(19) United States
(12) Patent Application Publication
(10) Pub. No.: US 2026/0058915 A1
(43) Pub. Date: Feb. 26, 2026

(54) TRAFFIC SCHEDULING METHOD FOR MULTIPLE TENANTS, MEDIUM AND ELECTRONIC DEVICE

(71) Applicant: Beijing Volcano Engine Technology Co., Ltd., Beijing (CN)

(72) Inventors: Jianong ZHONG, Beijing (CN); Fenghao ZHANG, Beijing (CN); Haijia SHEN, Beijing (CN); Haibin SHE, Beijing (CN); Pengwei ZHAO, Beijing (CN); Yunhao LI, Beijing (CN); Hang ZHANG, Beijing (CN); Yilong CHEN, Beijing (CN); Qin LI, Beijing (CN)

(21) Appl. No.: 19/242,470

(22) Filed: Jun. 18, 2025

(30) Foreign Application Priority Data
Aug. 21, 2024 (CN) 202411155625.5

(51) Int. Cl. H04L 47/6275; H04L 47/62

(52) U.S. Cl. CPC H04L 47/6275; H04L 47/6225

(57) ABSTRACT

The present disclosure provides a traffic scheduling method for multiple tenants, a medium and an electronic device. The method includes: receiving, by a storage node in a storage cluster, a tenant list sent by a control node in the storage cluster; determining, by the storage node, a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and controlling, based on the scheduler tree, traffic in and out of the storage cluster.

### CROSS-REFERENCE TO RELATED APPLICATION

The present application claims the priority to and benefits of the Chinese Patent Application No. 202411155625.5, which was filed on Aug. 21, 2024, the entire disclosure of which is incorporated herein by reference as portion of the present application.

### TECHNICAL FIELD

The present disclosure relates to a traffic scheduling method for multiple tenants, an apparatus, a medium, an electronic device and a program product.

### BACKGROUND

In an elastic block storage (EBS) system of a public cloud, a single EBS cluster will be shared by a certain number of tenants. Under this architecture of multiple tenants, the EBS system is required to have a quality management capability of input/output (IO) for multiple tenants.

In the related art, a multi-tenant IO quality management method is usually implemented as follows:
(1) a control node periodically collects feedback from storage nodes, makes decisions, allocates resources, and pushes the resources to the storage nodes according to the feedback from the storage nodes; and
(2) the storage nodes have basic real-time IO quality management capabilities, such as traffic limiting, IO scheduling based on a fixed priority, and the like. Traffic limiting refers to limiting the use of IO performance at a cloud disk level. IO scheduling based on a fixed priority refers to re-arranging the order of IOs based on priority marking when the IOs are queued, so as to serve high-priority IO as soon as possible.

This multi-tenant IO quality management method lacks real-time performance and flexibility.

### SUMMARY

The Summary is provided to introduce concepts in a concise form that are described in detail in the Detailed Description section below. This Summary is not intended to identify key features or essential features of the claimed technical solution, nor is it intended to be used to limit the scope of the claimed technical solution.

In a first aspect, the present disclosure provides a traffic scheduling method for multiple tenants based on elastic block storage, including: receiving, by a storage node in a storage cluster, a tenant list sent by a control node in the storage cluster, where the tenant list is used to maintain tenant names and tenant weights, and the tenant weights represent a proportion of service capabilities for storage enjoyed by respective tenants of the multiple tenants; determining, by the storage node, a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and controlling, based on the scheduler tree, traffic in and out of the storage cluster.

In a second aspect, the present disclosure provides a traffic scheduling apparatus for multiple tenants based on elastic block storage, including a reception module, a determination module, and a control module that are located on a storage node in a storage cluster, where the reception module is configured to receive a tenant list sent by a control node in the storage cluster, where the tenant list is used to maintain tenant names and tenant weights, and the tenant weights represent a proportion of service capabilities for storage enjoyed by respective tenants of the multiple tenants; the determination module is configured to determine a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and the control module is configured to control, based on the scheduler tree, traffic in and out of the storage cluster.

In a third aspect, the present disclosure provides a computer-readable medium having a computer program stored thereon, where when the computer program is executed by a processing apparatus, the steps of the method according to any one of the first aspect are implemented.

In a fourth aspect, the present disclosure provides an electronic device, including:
a storage apparatus having a computer program stored thereon; and
a processing apparatus, configured to execute the computer program in the storage apparatus to implement the steps of the method according to any one of the first aspect.

In a fifth aspect, the present disclosure provides a computer program product, including a computer program, where when the computer program is executed by a processor, the steps of the method according to any one of the first aspect are implemented.

### BRIEF DESCRIPTION OF DRAWINGS

The above and other features, advantages, and aspects of embodiments of the present disclosure will become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale. In the drawings:

FIG. 1 is a flowchart of a traffic scheduling method for multiple tenants based on elastic block storage according to an embodiment of the present disclosure.

FIG. 2 is a schematic diagram of a tenant list according to an embodiment of the present disclosure.

FIG. 3 is a schematic diagram of a scheduler tree according to an embodiment of the present disclosure.

FIG. 4 is a schematic diagram of fair round-robin scheduling according to an embodiment of the present disclosure.

FIG. 5 is another schematic diagram of fair round-robin scheduling according to an embodiment of the present disclosure.

FIG. 6 is a schematic block diagram of a traffic scheduling apparatus for multiple tenants based on elastic block storage according to an embodiment of the present disclosure.

FIG. 7 shows a schematic structural diagram of an electronic device suitable for implementing the embodiments of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the protection scope of the present disclosure.

It should be understood that the various steps described in the method implementations of the present disclosure may be performed in different orders and/or in parallel. Furthermore, a method implementation may include additional steps and/or omit performing the illustrated steps. The scope of the present disclosure is not limited in this respect.

As used herein, the term “include/comprise” and variations thereof are open-ended inclusions, that is, “include/comprise but not limited to”. The term “based on” is “at least partially based on”. The term “one embodiment” means “at least one embodiment”; the term “another embodiment” means “at least one additional embodiment”; and the term “some embodiments” means “at least some embodiments”.

Relevant definitions of other terms will be given in the following description.

It should be noted that the concepts of “first”, “second”, etc. mentioned in the present disclosure are only used to distinguish between different apparatuses, modules or units, and are not used to limit the order or interdependence of the functions performed by these apparatuses, modules or units.

It should be noted that the modifiers “one” and “multiple” mentioned in the present disclosure are illustrative and not restrictive, and those skilled in the art should understand that unless the context clearly indicates otherwise, it should be understood as “one or more”.

The names of messages or information exchanged between multiple apparatuses in the implementations of the present disclosure are only used for illustrative purposes and are not used to limit the scope of these messages or information.

It can be understood that before using the technical solutions disclosed in the embodiments of the present disclosure, the user should be informed of the type, usage scope, usage scenario, etc. of the personal information involved in the present disclosure in an appropriate manner according to relevant laws and regulations, and the user's authorization should be obtained.

For example, in response to receiving an active request from the user, prompt information is sent to the user to explicitly prompt the user that the operation requested to be performed will require the acquisition and use of the user's personal information. Thus, the user can independently select whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, in the form of a pop-up window, and the prompt information may be presented in the form of text in the pop-up window. In addition, the pop-up window may also carry a selection control for the user to select “agree” or “disagree” to provide personal information to the electronic device.

It can be understood that the above process of notifying and acquiring user authorization is only illustrative and does not constitute a limitation to the implementations of the present disclosure, and other manners that satisfy relevant laws and regulations may also be applied to the implementations of the present disclosure.

Meanwhile, it can be understood that the data involved in the technical solution (including but not limited to the data itself, the acquisition or use of the data) should comply with requirements of corresponding laws, regulations and relevant provisions.

In the EBS system of the public cloud, a single EBS cluster will be shared by a certain number of tenants and the EBS internal system, where the tenants here refer to customer tenants other than the EBS internal system. Under this architecture of multiple tenants, the EBS system is required to have a quality management capability of input/output (IO) for multiple tenants to achieve the following purposes:
(1) allocate service performance allocation for heterogeneous tenants. Different tenants have obvious heterogeneity in terms of storage IO quality requirements, and different tenants may have different expectations and requirements in terms of business importance, delay sensitivity, and other dimensions. The EBS system is required to recognize and adapt to these differences. For example, some tenants' critical business applications have strict requirements for IO performance, and expect stable low-latency IO quality to ensure the tenant experience. The EBS internal system has lower requirements for IO performance, for example, it can tolerate a certain degree of performance jitter, and can accept elasticity concession during the off-peak period of the critical business to improve resource utilization.
(2) provide isolation between tenants. When managing such shared resources, it is necessary to ensure the isolation of tenants and avoid the “disturbing neighbors” problem, that is, the isolation means that the tenants are unaware of each other and seem to monopolize the EBS cluster. For example, in a scenario where a certain tenant causes a high load on the EBS cluster, the EBS system should ensure that the impact of the high load on the IO quality is only borne by the tenant who caused the high load, while other tenants are hardly affected by this.

In the related art, a multi-tenant IO quality management method is usually implemented as follows:
(1) a control node periodically collects feedback from storage nodes, makes decisions, allocates resources, and pushes the resources to the storage nodes according to the feedback from the storage nodes; and
(2) the storage nodes have basic real-time IO quality management capabilities, such as traffic limiting, IO scheduling based on a fixed priority, and the like. Traffic limiting refers to limiting the use of IO performance at a cloud disk level. IO scheduling based on a fixed priority refers to re-arranging the order of IOs based on priority marking when the IOs are queued, so as to serve high-priority IO as soon as possible.

The above multi-tenant IO quality management method adopts a manner of “heavy control plane and light data plane”, which has obvious defects, mainly including the following problems:
(1) real-time performance problem. The path of feedback collection, decision-making, and pushing of the control node is too long, resulting in that the performance allocation and tenant isolation usually take effect at the second level and the ten-second level. Therefore, the real-time performance is insufficient, and the sub-second level of IO quality cannot be effectively managed. For example, if a certain tenant generates a large amount of burst load within 1 second, which causes the EBS system to be overloaded, all other tenants will be affected and experience jitter before the decision of the control node takes effect (the effective time is at the second level and the ten-second level).
(2) flexibility problem. The real-time IO quality management capability of the storage node is too simple (it mainly includes traffic limiting and IO scheduling based on a fixed priority), and cannot perceive specific tenant characteristics in a fine-grained manner. IO scheduling based on the fixed priority requires a system administrator to mark priorities for a large number of tenants in advance and mark them to several fixed priorities, which places too high requirements on the manual decision-making of the system administrator and is not flexible enough.

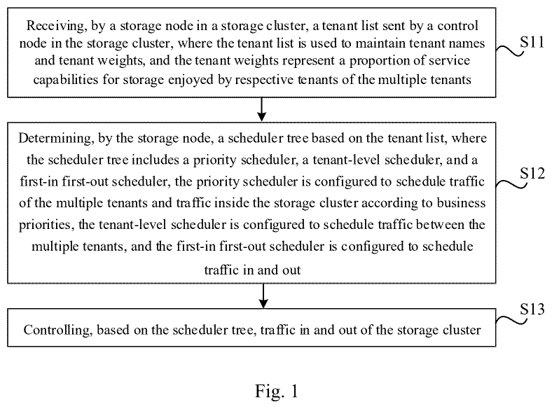

FIG. 1 is a flowchart of a traffic scheduling method for multiple tenants based on elastic block storage according to an embodiment of the present disclosure. The traffic scheduling method for multiple tenants based on elastic block storage can be applied to various multi-tenant traffic scheduling scenarios, for example, in the EBS system. As shown in FIG. 1, the traffic scheduling method for multiple tenants based on elastic block storage may include steps S11-S13.

In step S11, receiving, by a storage node in a storage cluster, a tenant list sent by a control node in the storage cluster, where the tenant list is used to maintain tenant names and tenant weights, and the tenant weights represent a proportion of service capabilities for storage enjoyed by respective tenants of the multiple tenants.

The storage node and the control node may be deployed in the storage cluster. The storage node refers to a node that implements data storage, for example, a node that implements data reading and writing. The control node refers to a node that is used to implement storage control.

Exemplarily, the control node may periodically push the tenant list to the storage node.

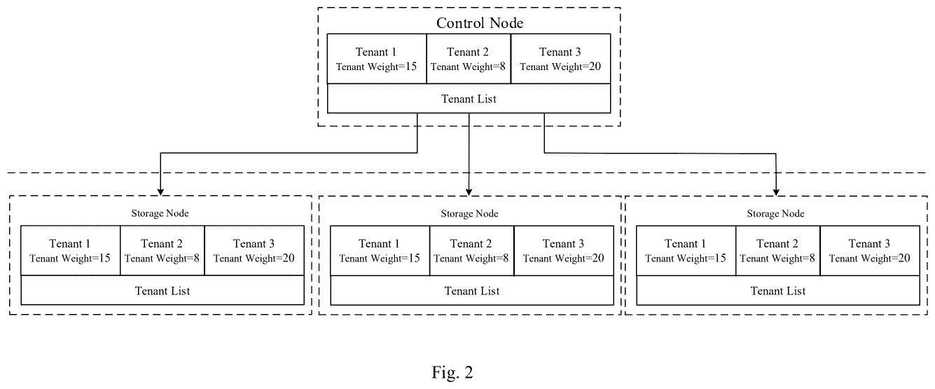

FIG. 2 is a schematic diagram of a tenant list according to an embodiment of the present disclosure. As shown in FIG. 2, the control node periodically pushes the tenant list to each storage node. The tenant list includes tenant names and tenant weights, for example, the tenant weight of Tenant 1 is 15, the tenant weight of Tenant 2 is 8, the tenant weight of Tenant 3 is 20, and so on. It should be noted that in FIG. 2, the number of control nodes and storage nodes, the number of tenants, and the tenant weights are all exemplary and do not constitute a limitation to the present disclosure.

In step S12, determining, by the storage node, a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out.

In step S13, controlling, based on the scheduler tree, traffic in and out of the storage cluster.

With above technical solutions, the tenant list sent by the control node in the storage cluster can be received by the storage node in the storage cluster, where the tenant list is used to maintain the tenant names and the tenant weight, and the tenant weights represent the proportion of service capabilities for storage enjoyed by respective tenants of the multiple tenants; then the scheduler tree is determined by the storage node based on the tenant list, where the scheduler tree includes the priority scheduler, the tenant-level scheduler, and the first-in first-out scheduler, the priority scheduler is configured to schedule the traffic of the tenant and the traffic inside the storage cluster according to the business priorities, the tenant-level scheduler is configured to schedule the traffic between the multiple tenants, and the first-in first-out scheduler is configured to schedule the traffic in and out; and then the traffic in and out of the storage cluster is controlled based on the scheduler tree. Therefore, in terms of the flexibility of multi-tenant traffic scheduling, the service performance allocation of the tenants can be allocated, and the isolation between the multiple tenants can be provided. For example, when the EBS cluster is at a high load, the delay increase of the tenant which does not cause the high load is only at a ten-microsecond level, so that the tenant isolation is effectively provided. In terms of the real-time performance of multi-tenant traffic scheduling, by executing multi-tenant traffic scheduling on the storage node, the intervention effective time of multi-tenant traffic scheduling can be reduced from the second level and the ten-second level of the mainstream solution in the industry to the hundred-microsecond level, effectively reducing the jitter in the burst load scenario.

In some embodiments, the determining, by the storage node, the scheduler tree based on the tenant list in step S12 may include: initially constructing or updating, by the storage node, a scheduler tree with a three-layer tree structure based on the tenant list, where a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, the priority scheduler is configured to fairly schedule traffic among the business priorities in a manner of round-robin based on service weights of the business priorities, the tenant-level scheduler is configured to fairly schedule traffic among the multiple tenants in a manner of round-robin based on the tenant weights, and the first-in first-out scheduler is configured to schedule traffic based on a first-in first-out principle.

After the storage node acquires the tenant list from the control node for the first time, the scheduler tree may be initially constructed. After the storage node acquires the tenant list from the control node again, the previously constructed scheduler tree may be updated.

Exemplarily, the priority scheduler is configured with a plurality of priorities, each of the plurality of priorities is allocated an independent queue, each priority is configured with respective one of the service weights, and isolation and service performance allocation are performed based on the service weights, where each priority corresponds to a sub-priority scheduler for serving traffic scheduling of a business corresponding to each priority, where a sub-priority scheduler of a first priority of the plurality of priorities is configured to serve the traffic of the multiple tenants on the storage cluster, sub-priority schedulers of other priorities than the first priority are configured to serve the traffic inside the storage cluster, and a service weight corresponding to the first priority is greater than service weights corresponding to the other priorities.

Exemplarily, the priority scheduler is configured with a plurality of priorities, where each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

Exemplarily, the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

Exemplarily, the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.

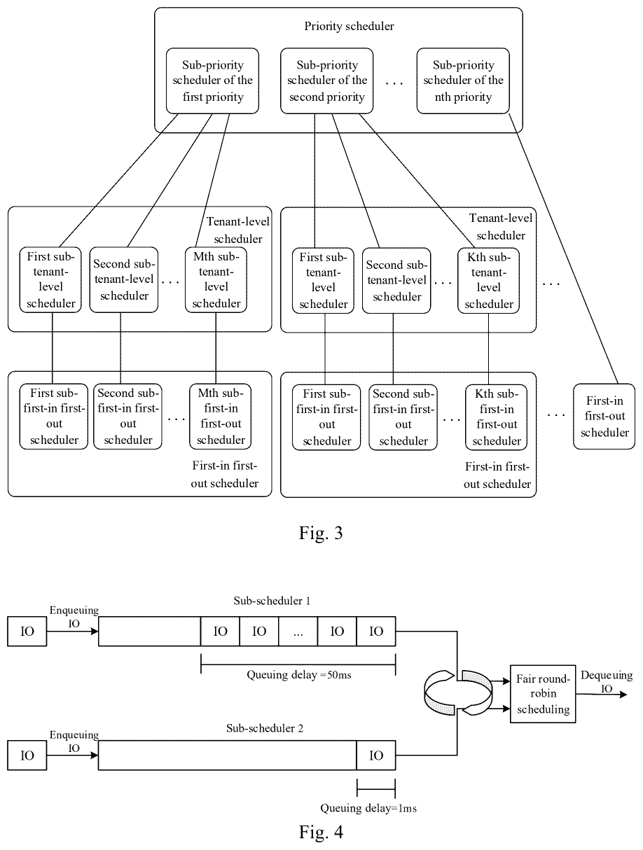

FIG. 3 is a schematic diagram of a scheduler tree according to an embodiment of the present disclosure. The scheduler tree is used in a storage node.

As shown in FIG. 3, the scheduler tree according to the embodiment of the present disclosure includes 3 levels (layers).

The first level is the priority scheduler. This level is divided into a plurality of sub-priority schedulers according to service priorities.

Each priority corresponds to one sub-priority scheduler, and the higher the priority, the higher the service capability of the corresponding sub-priority scheduler. For example, in FIG. 3, the sub-priority scheduler of the first priority has the highest priority, and then the priority decreases in turn, and the sub-priority scheduler of the nth priority has the lowest priority. The specific value of n may be set according to actual needs, for example, it may be 5.

The sub-priority scheduler with the highest priority (that is, the sub-priority scheduler of the first priority in FIG. 3) is used to serve the IO of the tenant, and the sub-priority schedulers of other priorities (for example, the sub-priority scheduler of the fourth priority) are used to serve the IO of the internal system of the storage cluster (for example, the EBS cluster). Since tenants generally have more IO requirements than the internal system of the storage cluster, configuring the sub-priority scheduler with the highest priority to the tenant can ensure the IO quality provided to the tenant.

Fair round-robin scheduling may be performed between the sub-priority schedulers of all priorities (which will be described in detail below). Fair round-robin scheduling refers to a traffic scheduling strategy, that is, fair round-robin dequeue scheduling between IO queues, and fairness means that all IO queues have guaranteed service capabilities of weight proportions; and fair round-robin scheduling may be driven by virtual time.

The proportion of the service capabilities between the sub-priority schedulers may be preset. Taking an example that the first level includes 5 priorities in total, the proportion of the service capabilities (that is, the service weights) from the sub-priority scheduler with the highest priority to the sub-priority scheduler with the lowest priority may be preset to 16:8:4:2:1. When performing fair round-robin scheduling, fair round-robin may be performed according to the proportion of the service capabilities between the sub-priority schedulers, for example, the sub-priority scheduler that is currently fairly scheduled may be determined according to the proportion of the service capabilities between the sub-priority schedulers. Through fair round-robin scheduling, both the isolation of the traffic scheduling and the performance allocation of the traffic scheduling can be ensured.

If the service capability of the sub-priority scheduler of any priority is not fully used, the redundant service capability of the sub-priority scheduler may be elastically released to the sub-priority schedulers of other priorities. For example, assuming that the service capability of a certain sub-priority scheduler is not fully used currently, and the sub-priority scheduler is currently fairly scheduled, then the sub-priority scheduler may give up the opportunity to schedule the IO to other sub-priority schedulers which are busy in scheduling IOs. Through the release of the service capability, the resource utilization can be improved.

In addition, the IO queues scheduled by the respective sub-priority schedulers are independent, so as to provide performance allocation capabilities for the tenant and the traffic of the internal system of the storage cluster.

The second level (layer) is the tenant-level scheduler, and this layer is a sub-layer of the priority scheduler.

The tenant-level scheduler may exist under each of the sub-priority schedulers, or may exist under some of the sub-priority schedulers. Preferably, the tenant-level scheduler only exists under the sub-priority scheduler with the highest priority to serve the IO of the tenant. By causing the sub-priority scheduler with the highest priority to serve the IO of the tenant and only having the tenant-level scheduler under the sub-priority scheduler with the highest priority, on the one hand, the structure of the scheduler tree can be simplified, and on the other hand, the IO quality management requirements (such as isolation, real-time performance, flexibility, etc.) of the tenant can be met with the help of the scheduler tree.

The number of tenant-level schedulers under the corresponding sub-priority scheduler corresponds to the number of tenants under the priority, and each tenant corresponds to one sub-tenant-level scheduler, thereby providing isolation for the tenants.

Fair round-robin scheduling may be performed between the sub-tenant-level schedulers under the same sub-priority scheduler (which will be described in detail below). Fair round-robin scheduling refers to a traffic scheduling strategy, that is, fair round-robin dequeue scheduling between IO queues, and fairness means that all IO queues have guaranteed service capabilities of weight proportions, and fair round-robin scheduling may be driven by virtual time.

The proportion of the service capabilities between the sub-tenant-level schedulers under the same sub-priority scheduler is determined by the tenant weights of the tenants under the sub-priority scheduler. When performing fair round-robin scheduling, fair round-robin may be performed according to the proportion of the service capabilities between the sub-tenant-level schedulers, for example, the sub-tenant-level scheduler that is currently fairly scheduled may be determined according to the proportion of the service capabilities between the sub-tenant-level schedulers. Through fair round-robin scheduling, both the isolation of the traffic scheduling and the performance allocation of the traffic scheduling can be ensured.

In addition, if the service capability of any sub-tenant-level scheduler is not fully used, the redundant service capability of the sub-tenant-level scheduler may be elastically released to other sub-tenant-level schedulers. For example, assuming that the service capability of a certain sub-tenant-level scheduler is not fully used currently, and the sub-tenant-level scheduler is currently fairly scheduled, then the sub-tenant-level scheduler may give up the opportunity to schedule the IO to other sub-tenant-level schedulers which are busy in scheduling IOs. Through the release of the service capability, the resource utilization can be improved.

The third level (layer) is the first-in first-out scheduler, and this layer is a sub-layer of the tenant-level scheduler. The first-in first-out scheduler is used to carry actual IO enqueue operations and IO dequeue operations. When there is a sub-tenant-level scheduler under the corresponding sub-priority scheduler, there is one sub-first-in first-out scheduler under each sub-tenant-level scheduler; since one tenant corresponds to one sub-tenant-level scheduler, one tenant also corresponds to one sub-first-in first-out scheduler, thereby realizing tenant isolation. When there is no sub-tenant-level scheduler under the corresponding sub-priority scheduler, there is one sub-first-in first-out scheduler directly under the sub-priority scheduler.

Through the scheduler tree according to the embodiment of the present disclosure, the multi-tenant traffic scheduling (that is, IO quality management) capability of the storage node is expanded, so that the storage node can directly support the allocation of service performance for heterogeneous tenants and directly provide isolation between the tenants. With the help of the scheduler tree used in the storage node, the core capability of multi-tenant traffic scheduling can be “unloaded” from the control node to the storage node, and the resource allocation problem of the control node is transformed into the traffic scheduling problem of the storage node, which greatly improves the flexibility and real-time performance of multi-tenant traffic scheduling. In the present disclosure, the IO quality may include IO delay, jitter, performance capabilities, and the like.

In some embodiments, the controlling, based on the scheduler tree, traffic in and out of the storage cluster in step S13 may include:
determining a first target first-in first-out scheduler based on a tenant to which the inbound traffic belongs or a priority to which the inbound traffic belongs, and performing traffic enqueuing based on the first target first-in first-out scheduler; or
determining a second target first-in first-out scheduler based on a tenant to which the outbound traffic belongs and a priority to which the outbound traffic belongs, and performing traffic dequeuing based on the second target first-in first-out scheduler; or determining a third target first-in first-out scheduler based on a priority to which the outbound traffic belongs, and performing traffic dequeuing based on the third target first-in first-out scheduler.

For example, when the sub-priority scheduler to which the IO to be enqueued belongs is the sub-priority scheduler of the first priority, and the sub-tenant-level scheduler to which the IO to be enqueued belongs is the first sub-tenant-level scheduler under the sub-priority scheduler of the first priority, then the first target first-in first-out scheduler of the leaf node in the scheduler tree can be found accordingly, and the IO enqueuing is performed by the first target first-in first-out scheduler. In this way, the IO can be quickly enqueued.

For another example, in a scenario where an IO is dequeued, when there is no sub-tenant-level scheduler but only a sub-first-in first-out scheduler under a sub-priority scheduler in some branches of the scheduler tree, in this case, in response to the sub-priority scheduler of the branch being fairly scheduled, the sub-first-in first-out scheduler under the fairly scheduled sub-priority scheduler schedules the IO dequeuing for the corresponding tenant.

For another example, in a scenario where an IO is dequeued, the sub-priority scheduler that is currently fairly scheduled may be determined first, then the sub-tenant-level scheduler that is currently fairly scheduled under the sub-priority scheduler that is currently fairly scheduled may be determined, and then, the sub-first-in first-out scheduler under the sub-tenant-level scheduler that is currently fairly scheduled may be used to schedule the IO dequeuing.

With above technical solutions, the real-time performance and flexibility of traffic scheduling can be achieved on the storage node through fair round-robin scheduling of each sub-priority scheduler and each sub-tenant-level scheduler, that is, every time an IO is dequeued from the scheduler tree, an appropriate scheduler is determined at each level according to the fair round-robin scheduling, and so on recursively down until the first-in first-out scheduler of a leaf node is reached, and the IO is dequeued. In terms of flexibility, both the performance allocation of the tenants can be allocated and the isolation between the tenants can be provided. For example, when the storage cluster is at a high load, the delay increase of the tenant which does not cause the high load is only at a ten-microsecond level, so that the tenant isolation is effectively provided. In terms of real-time performance, the intervention effective time of multi-tenant traffic scheduling is reduced from the second level and the ten-second level of the mainstream solution in the industry to the hundred-microsecond level, effectively reducing the jitter in the burst load scenario. For example, for a burst response time, the effect that can be achieved by the mainstream solution in the industry is at a level of 1 s˜10 s, while the effect that can be achieved by the traffic scheduling method for multiple tenants according to the present disclosure is at a level of 100 μs; for a burst jitter, the effect that can be achieved by the mainstream solution in the industry is a delay increase of more than 10 ms, while the effect that can be achieved by the traffic scheduling method for multiple tenants according to the present disclosure is a maximum delay increase of 100 μs.

FIG. 4 is a schematic diagram of fair round-robin scheduling according to an embodiment of the present disclosure. The sub-scheduler 1 and the sub-scheduler 2 in FIG. 4 may be sub-priority schedulers or sub-tenant-level schedulers.

As shown in FIG. 4, IOs are dequeued in turn between the sub-schedulers.

When a sub-scheduler (for example, the sub-scheduler 2 in FIG. 4) does not fully use the performance allocated by fair round-robin scheduling, its IOs will hardly queue, resulting in an effect of isolation between the sub-schedulers. The corresponding isolation effect between the sub-priority schedulers can be achieved according to their preset proportion of the service capabilities; and the corresponding isolation effect between the sub-tenant-level schedulers can be achieved according to corresponding tenant weights.

For example, assuming that the sub-scheduler 1 schedules the IO of the Tenant 1 which causes the high load, and the sub-scheduler 2 schedules the IO of other Tenant 2, then through fair round-robin scheduling, the Tenant 2 will not experience the queuing delay caused by the high load of the Tenant 1, that is, isolation is provided between the Tenant 1 and the Tenant 2, and the impact of the high load on the IO quality is only borne by the Tenant 1 who causes the high load (for example, the queuing delay of the sub-scheduler 1 in FIG. 4 is 50 ms), while the Tenant 2 is not affected by this (for example, the queuing delay of the sub-scheduler 2 in FIG. 4 is 1 ms). It should be noted that the specific queuing delay value in FIG. 4 is only to illustrate that the impact of the high load on the IO quality is only borne by the tenant who causes the high load, while other tenants are hardly affected by this, and does not constitute a limitation to the present disclosure.

Through the adoption of the above fair round-robin scheduling, the isolation capability between tenants can be provided.

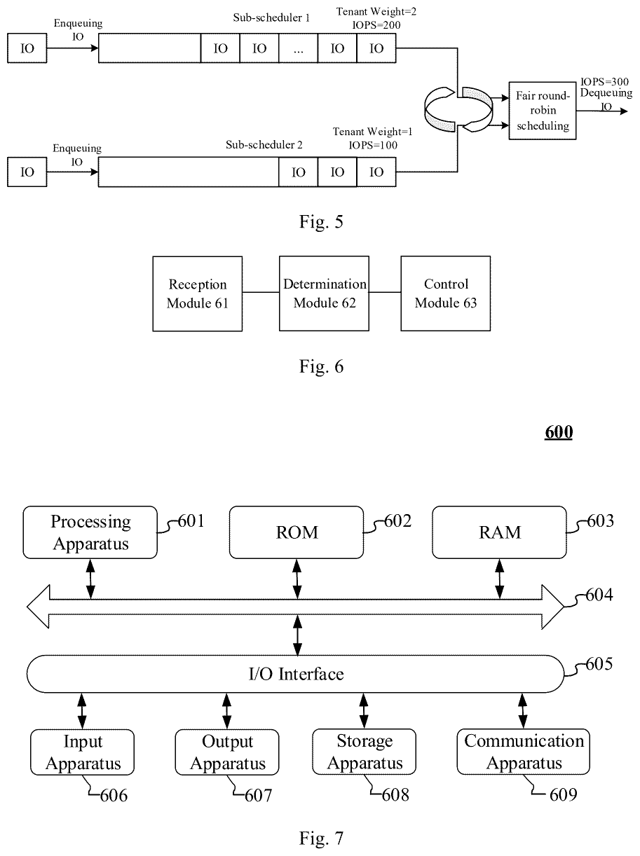

FIG. 5 is another schematic diagram of fair round-robin scheduling according to an embodiment of the present disclosure. The sub-scheduler 1 and the sub-scheduler 2 in FIG. 5 may be sub-priority schedulers or sub-tenant-level schedulers.

As shown in FIG. 5, IOs are dequeued in turn between the sub-schedulers. The frequency of IO dequeuing of each sub-scheduler is proportional to its service capability. For a sub-priority scheduler, the frequency of its IO dequeuing is proportional to its preset proportion of the service capability. For a sub-tenant-level scheduler, the frequency of its IO dequeuing is proportional to the tenant weight. The frequency of IO dequeuing may be represented by the number of input/output operations per second (IOPS). For example, as shown in FIG. 5, the total IOPS is 300. Since the tenant weight of the tenant scheduled by the sub-scheduler 1 is 2, and the tenant weight of the tenant scheduled by the sub-scheduler 2 is 1, the IOPS of the sub-scheduler 1 is 200, and the IOPS of the sub-scheduler 2 is 100, that is, proportional to its tenant weight. It should be noted that the IOPS value, the value of the tenant weight, etc. in FIG. 5 are all examples and do not constitute a limitation to the present disclosure.

Through the above fair round-robin scheduling, the performance allocation of the IO scheduling can be achieved.

FIG. 6 is a schematic block diagram of a traffic scheduling apparatus for multiple tenants based on elastic block storage according to an embodiment of the present disclosure. As shown in FIG. 6, the traffic scheduling apparatus for multiple tenants based on elastic block storage may include a reception module 61, a determination module 62, and a control module 63 that are located on a storage node in a storage cluster, where:
the reception module 61 is configured to receive a tenant list sent by a control node in the storage cluster, where the tenant list is used to maintain tenant names and tenant weights, and the tenant weights represent a proportion of service capabilities for storage enjoyed by respective tenants of the multiple tenants;
the determination module 62 is configured to determine a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and
the control module 63 is configured to control, based on the scheduler tree, traffic in and out of the storage cluster.

With above technical solutions, the tenant list sent by the control node in the storage cluster can be received by the storage node in the storage cluster, where the tenant list is used to maintain the tenant names and the tenant weight, and the tenant weights represent the proportion of service capabilities for storage enjoyed by respective tenants of the multiple tenants; then the scheduler tree is determined by the storage node based on the tenant list, where the scheduler tree includes the priority scheduler, the tenant-level scheduler, and the first-in first-out scheduler, the priority scheduler is configured to schedule the traffic of the tenant and the traffic inside the storage cluster according to the business priorities, the tenant-level scheduler is configured to schedule the traffic between the multiple tenants, and the first-in first-out scheduler is configured to schedule the traffic in and out; and then the traffic in and out of the storage cluster is controlled based on the scheduler tree. Therefore, in terms of the flexibility of multi-tenant traffic scheduling, the service performance allocation of the tenants can be allocated, and the isolation between the multiple tenants can be provided. For example, when the EBS cluster is at a high load, the delay increase of the tenant which does not cause the high load is only at a ten-microsecond level, so that the tenant isolation is effectively provided. In terms of the real-time performance of multi-tenant traffic scheduling, by executing multi-tenant traffic scheduling on the storage node, the intervention effective time of multi-tenant traffic scheduling can be reduced from the second level and the ten-second level of the mainstream solution in the industry to the hundred-microsecond level, effectively reducing the jitter in the burst load scenario.

Optionally, the determining, by the determination module 62, a scheduler tree by the storage node based on the tenant list includes:
initially constructing or updating, by the storage node, a scheduler tree with a three-layer tree structure based on the tenant list, where a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, the priority scheduler is configured to fairly schedule traffic among the service priorities in a manner of round-robin based on service weights of the business priorities, the tenant-level scheduler is configured to fairly schedule traffic among the multiple tenants in a manner of round-robin based on the tenant weight, and the first-in first-out scheduler is configured to schedule traffic based on a first-in first-out principle.

Optionally, the priority scheduler is configured with multiple priorities, each priority is allocated an independent queue, each priority is configured with respective one of the service weights, and isolation and service performance allocation are performed based on the service weights, where each priority corresponds to a sub-priority scheduler for serving traffic scheduling of a business corresponding to each priority, where a sub-priority scheduler of a first priority of the plurality of priorities is configured to serve the traffic of the multiple tenants on the storage cluster, sub-priority schedulers of other priorities than the first priority are used to serve the traffic inside the storage cluster, and the service weight corresponding to the first priority is greater than the service weights corresponding to the other priorities.

Optionally, the priority scheduler is configured with multiple priorities, where each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

Optionally, the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

Optionally, the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.

Optionally, the controlling, by the control module 63, traffic in and out of the storage cluster based on the scheduler tree includes:
determining a first target first-in first-out scheduler based on a tenant to which the inbound traffic belongs or a priority to which the inbound traffic belongs, and performing traffic enqueuing based on the first target first-in first-out scheduler; or
determining a second target first-in first-out scheduler based on a tenant to which the outbound traffic belongs and a priority to which the outbound traffic belongs, and performing traffic dequeuing based on the second target first-in first-out scheduler; or determining a third target first-in first-out scheduler based on a priority to which the outbound traffic belongs, and performing traffic dequeuing based on the third target first-in first-out scheduler.

The specific implementations of operations performed by the modules in the traffic scheduling apparatus for multiple tenants based on elastic block storage according to the embodiments of the present disclosure have been described in detail in the related traffic scheduling method for multiple tenants based on elastic block storage, and will not be repeated here.

The present disclosure also provides a computer-readable medium having a computer program stored thereon, where when the computer program is executed by a processing apparatus, the steps of the method according to any one of the present disclosure are implemented.

The present disclosure also provides an electronic device, including:
a storage apparatus having a computer program stored thereon; and
a processing apparatus configured to execute the computer program in the storage apparatus to implement the steps of the method according to any one of the present disclosure.

The present disclosure also provides a computer program product, including a computer program, where when the computer program is executed by a processor, the steps of the method according to any one of the present disclosure are implemented.

Reference is made to FIG. 7 below, which shows a schematic structural diagram of an electronic device 600 suitable for implementing the embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (tablet computer), a PMP (portable multimedia player), a vehicle-mounted terminal (such as a vehicle-mounted navigation terminal), and the like, and a fixed terminal such as a digital TV, a desktop computer, and the like. The electronic device shown in FIG. 7 is only an example and should not bring any limitation to the function and usage scope of the embodiments of the present disclosure.

As shown in FIG. 7, the electronic device 600 may include a processing apparatus (such as a central processing unit, a graphics processor, etc.) 601, which may perform various appropriate actions and processing according to a program stored in a read-only memory (ROM) 602 or a program loaded from a storage apparatus 608 into a random access memory (RAM) 603. In the RAM 603, various programs and data required for the operation of the electronic device 600 are also stored. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606, including, for example, a touchscreen, a touchpad, a keyboard, a mouse, a camera, a microphone, an accelerometer, a gyroscope, etc.; an output apparatus 607, including, for example, a liquid crystal display (LCD), a speaker, a vibrator, etc.; a storage apparatus 608, including, for example, a magnetic tape, a hard disk, etc.; and a communication apparatus 609. The communication apparatus 609 may allow the electronic device 600 to perform wireless or wired communication with other devices to exchange data. Although FIG. 7 shows the electronic device 600 having various apparatuses, it should be understood that it is not required to implement or have all the illustrated apparatuses. Alternatively, more or fewer apparatuses may be implemented or provided.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program codes for executing the method shown in the flowchart. In such embodiment, the computer program may be downloaded and installed from a network via the communication apparatus 609, or installed from the storage apparatus 608, or installed from the ROM 602. When the computer program is executed by the processing apparatus 601, the above functions defined in the method of the embodiment of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus, or device. In the present disclosure, the computer-readable signal medium may include a data signal propagated in a baseband or as a part of a carrier wave, in which computer-readable program codes are carried. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to an electrical wire, an optical cable, radio frequency (RF), or any suitable combination thereof.

In some implementations, the client and the server may communicate using any currently known or future developed network protocol such as the hypertext transfer protocol (HTTP), and may communicate and interconnect with digital data in any form or medium (for example, a communication network). Examples of the communication network include a local area network (“LAN”), a wide area network (“WAN”), an internet (for example, the Internet), a peer-to-peer network (for example, an ad hoc peer-to-peer network), and any currently known or future developed network.

The above computer-readable medium may be included in the above electronic device, or may exist alone without being assembled into the electronic device.

The above computer-readable medium carries one or more programs, and when the one or more programs are executed by the electronic device, the electronic device is caused to: receive, by a storage node in a storage cluster, a tenant list sent by a control node in the storage cluster, where the tenant list is used to maintain tenant names and tenant weights, and the tenant weights represent a proportion of service capabilities for storage enjoyed by respective tenants of the multiple tenants; determine, by the storage node, a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and control, based on the scheduler tree, traffic in and out of the storage cluster.

The computer program codes for performing the operations of the present disclosure may be written in one or more programming languages or a combination thereof, where the above programming languages include but are not limited to object-oriented programming languages such as Java, Smalltalk, C++, and also include conventional procedural programming languages such as “C” programming language or similar programming languages. The program codes may be executed entirely on a user computer, partly on a user computer, as a stand-alone software package, partly on a user computer and partly on a remote computer, or entirely on a remote computer or a server. In the scenario involving the remote computer, the remote computer may be connected to the user computer through any type of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions marked in the blocks may also occur in an order different from those marked in the drawings. For example, two blocks shown in succession may, in fact, be executed substantially concurrently, or the two blocks may sometimes be executed in a reverse order, depending on the functions involved. It should also be noted that, each block of the block diagrams and/or flowcharts, and a combination of blocks in the block diagrams and/or flowcharts, may be implemented by a dedicated hardware-based system that performs the specified functions or operations, or may be implemented by a combination of dedicated hardware and computer instructions.

The modules involved in the embodiments described in the present disclosure may be implemented in software or hardware. The name of the module does not constitute a limitation to the module itself under certain circumstances. For example, the reception module may also be described as “a module for receiving a tenant list sent by a control node in a storage cluster”.

The functions described herein above may be performed, at least partially, by one or more hardware logic components. For example, without limitation, available exemplary types of hardware logic components include: a field-programmable gate array (FPGA), an application specific integrated circuit (ASIC), an application specific standard product (ASSP), a system on a chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a traffic scheduling method for multiple tenants based on elastic block storage, including:
receiving, by a storage node in a storage cluster, a tenant list sent by a control node in the storage cluster, where the tenant list is used to maintain tenant names and tenant weights, and the tenant weights represent a proportion of service capabilities for storage enjoyed by respective tenants of the multiple tenants;
determining, by the storage node, a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and controlling, based on the scheduler tree, traffic in and out of the storage cluster.

According to one or more embodiments of the present disclosure, Example 2 provides the traffic scheduling method for multiple tenants based on elastic block storage of Example 1, where the determining, by the storage node, the scheduler tree based on the tenant list includes:
initially constructing or updating, by the storage node, a scheduler tree with a three-layer tree structure based on the tenant list, where a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, the priority scheduler is configured to fairly schedule traffic among the service priorities in a manner of round-robin based on service weights of the business priorities, the tenant-level scheduler is configured to fairly schedule traffic among the multiple tenants in a manner of round-robin based on the tenant weight, and the first-in first-out scheduler is configured to schedule traffic based on a first-in first-out principle.

According to one or more embodiments of the present disclosure, Example 3 provides the traffic scheduling method for multiple tenants based on elastic block storage of Example 1 or 2, the priority scheduler is configured with multiple priorities, each of the plurality of priorities is allocated an independent queue, each priority is configured with respective one of the service weights, and isolation and service performance allocation are performed based on the service weights, where each priority corresponds to a sub-priority scheduler for serving traffic scheduling of a business corresponding to each priority, where a sub-priority scheduler of a first priority of the plurality of priorities is configured to serve the traffic of the multiple tenants on the storage cluster, sub-priority schedulers of other priorities than the first priority are used to serve the traffic inside the storage cluster, and the service weight corresponding to the first priority is greater than the service weights corresponding to the other priorities.

According to one or more embodiments of the present disclosure, Example 4 provides the traffic scheduling method for multiple tenants based on elastic block storage of Example 1 or 2, the priority scheduler is configured with multiple priorities, where each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

According to one or more embodiments of the present disclosure, Example 5 provides the traffic scheduling method for multiple tenants based on elastic block storage of Example 1 or 2, where the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

According to one or more embodiments of the present disclosure, Example 6 provides the traffic scheduling method for multiple tenants based on elastic block storage of Example 1 or 2, where the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.

According to one or more embodiments of the present disclosure, Example 7 provides the traffic scheduling method for multiple tenants based on elastic block storage of Example 1 or 2, where the controlling, based on the scheduler tree, traffic in and out of the storage cluster includes:
determining a first target first-in first-out scheduler based on a tenant to which the inbound traffic belongs or a priority to which the inbound traffic belongs, and performing traffic enqueuing based on the first target first-in first-out scheduler; or
determining a second target first-in first-out scheduler based on a tenant to which the outbound traffic belongs and a priority to which the outbound traffic belongs, and performing traffic dequeuing based on the second target first-in first-out scheduler; or determining a third target first-in first-out scheduler based on a priority to which the outbound traffic belongs, and performing traffic dequeuing based on the third target first-in first-out scheduler.

According to one or more embodiments of the present disclosure, Example 8 provides a traffic scheduling apparatus for multiple tenants based on elastic block storage, including a reception module, a determination module, and a control module that are located on a storage node in a storage cluster, where:
the reception module is configured to receive a tenant list sent by a control node in the storage cluster, where the tenant list is used to maintain tenant names and tenant weights, and the tenant weights represent a proportion of service capabilities for storage enjoyed by respective tenants of the multiple tenants;
the determination module is configured to determine a scheduler tree based on the tenant list, where the scheduler tree includes a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and
the control module is configured to control, based on the scheduler tree, traffic in and out of the storage cluster.

According to one or more embodiments of the present disclosure, Example 9 provides a computer-readable medium having a computer program stored thereon, where when the computer program is executed by a processing apparatus, the steps of the method according to any one of Examples 1-7 are implemented.

According to one or more embodiments of the present disclosure, Example 10 provides an electronic device, including:
a storage apparatus having a computer program stored thereon; and
a processing apparatus configured to execute the computer program in the storage apparatus to implement the steps of the method according to any one of Examples 1-7.

According to one or more embodiments of the present disclosure, Example 11 provides a computer program product, including a computer program, where when the computer program is executed by a processor, the steps of the method according to any one of Examples 1-7 are implemented.

The above description is only preferred embodiments of the present disclosure and an illustration of the applied technical principles. Those skilled in the art should understand that the disclosure scope involved in the present disclosure is not limited to the technical solutions formed by the specific combination of the above technical features, and should also cover other technical solutions formed by any combination of the above technical features or equivalent features thereof without departing from the above disclosure concept. For example, the technical solution formed by replacing the above features with the technical features disclosed in the present disclosure (but not limited to) having similar functions.

In addition, although various operations are depicted in a specific order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims. Regarding the apparatus in the above embodiments, the specific manner in which the respective modules perform operations has been described in detail in the embodiments related to the method, and will not be described in detail here.

1. A traffic scheduling method for multiple tenants based on elastic block storage, comprising:
receiving, by a storage node in a storage cluster, a tenant list sent by a control node in the storage cluster, wherein the tenant list is used to maintain tenant names and tenant weights, and the tenant weights represent a proportion of service capabilities for storage enjoyed by respective tenants of the multiple tenants;
determining, by the storage node, a scheduler tree based on the tenant list, wherein the scheduler tree comprises a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and
controlling, based on the scheduler tree, traffic in and out of the storage cluster.

2. The traffic scheduling method for multiple tenants based on elastic block storage according to claim 1, wherein the determining, by the storage node, the scheduler tree based on the tenant list comprises:
initially constructing or updating, by the storage node, a scheduler tree with a three-layer tree structure based on the tenant list, wherein a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, wherein the priority scheduler is configured to fairly schedule traffic among the business priorities in a manner of round-robin based on service weights of the business priorities, the tenant-level scheduler is configured to fairly schedule traffic among the multiple tenants in a manner of round-robin based on the tenant weights, and the first-in first-out scheduler is configured to schedule traffic based on a first-in first-out principle.

3. The traffic scheduling method for multiple tenants based on elastic block storage according to claim 1, wherein the priority scheduler is configured with a plurality of priorities, each of the plurality of priorities is allocated an independent queue, each priority is configured with respective one of the service weights, and isolation and service performance allocation are performed based on the service weights, wherein each priority corresponds to a sub-priority scheduler for serving traffic scheduling of a business corresponding to each priority, wherein a sub-priority scheduler of a first priority of the plurality of priorities is configured to serve the traffic of the multiple tenants on the storage cluster, sub-priority schedulers of other priorities than the first priority are configured to serve the traffic inside the storage cluster, and a service weight corresponding to the first priority is greater than service weights corresponding to the other priorities.

4. The traffic scheduling method for multiple tenants based on elastic block storage according to claim 1, wherein the priority scheduler is configured with a plurality of priorities, each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

5. The traffic scheduling method for multiple tenants based on elastic block storage according to claim 1, wherein the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

6. The traffic scheduling method for multiple tenants based on elastic block storage according to claim 1, wherein the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.

7. The traffic scheduling method for multiple tenants based on elastic block storage according to claim 1, wherein the controlling, based on the scheduler tree, traffic in and out of the storage cluster comprises:
determining a first target first-in first-out scheduler based on a tenant to which inbound traffic belongs or a priority to which the inbound traffic belongs, and performing traffic enqueuing based on the first target first-in first-out scheduler; or
determining a second target first-in first-out scheduler based on a tenant to which outbound traffic belongs and a priority to which the outbound traffic belongs, and performing traffic dequeuing based on the second target first-in first-out scheduler; or determining a third target first-in first-out scheduler based on a priority to which the outbound traffic belongs, and performing traffic dequeuing based on the third target first-in first-out scheduler.

8. A non-transitory computer-readable medium having a computer program stored thereon, wherein when the computer program is executed by a processing apparatus, a traffic scheduling method for multiple tenants based on elastic block storage is implemented, which comprises:
receiving, by a storage node in a storage cluster, a tenant list sent by a control node in the storage cluster, wherein the tenant list is used to maintain tenant names and tenant weights, and the tenant weights represent a proportion of service capabilities for storage enjoyed by respective tenants of the multiple tenants;
determining, by the storage node, a scheduler tree based on the tenant list, wherein the scheduler tree comprises a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and
controlling, based on the scheduler tree, traffic in and out of the storage cluster.

9. The non-transitory computer-readable medium according to claim 8, wherein the determining, by the storage node, the scheduler tree based on the tenant list comprises:
initially constructing or updating, by the storage node, a scheduler tree with a three-layer tree structure based on the tenant list, wherein a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, wherein the priority scheduler is configured to fairly schedule traffic among the business priorities in a manner of round-robin based on service weights of the business priorities, the tenant-level scheduler is configured to fairly schedule traffic among the multiple tenants in a manner of round-robin based on the tenant weights, and the first-in first-out scheduler is configured to schedule traffic based on a first-in first-out principle.

10. The non-transitory computer-readable medium according to claim 8, wherein the priority scheduler is configured with a plurality of priorities, each of the plurality of priorities is allocated an independent queue, each priority is configured with respective one of the service weights, and isolation and service performance allocation are performed based on the service weights, wherein each priority corresponds to a sub-priority scheduler for serving traffic scheduling of a business corresponding to each priority, wherein a sub-priority scheduler of a first priority of the plurality of priorities is configured to serve the traffic of the multiple tenants on the storage cluster, sub-priority schedulers of other priorities than the first priority are configured to serve the traffic inside the storage cluster, and a service weight corresponding to the first priority is greater than service weights corresponding to the other priorities.

11. The non-transitory computer-readable medium according to claim 8, wherein the priority scheduler is configured with a plurality of priorities, each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

12. The non-transitory computer-readable medium according to claim 8, wherein the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

13. The non-transitory computer-readable medium according to claim 8, wherein the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.

14. The non-transitory computer-readable medium according to claim 8, wherein the controlling, based on the scheduler tree, traffic in and out of the storage cluster comprises:
determining a first target first-in first-out scheduler based on a tenant to which inbound traffic belongs or a priority to which the inbound traffic belongs, and performing traffic enqueuing based on the first target first-in first-out scheduler; or
determining a second target first-in first-out scheduler based on a tenant to which outbound traffic belongs and a priority to which the outbound traffic belongs, and performing traffic dequeuing based on the second target first-in first-out scheduler; or determining a third target first-in first-out scheduler based on a priority to which the outbound traffic belongs, and performing traffic dequeuing based on the third target first-in first-out scheduler.

15. An electronic device, comprising:
a storage apparatus having a computer program stored thereon; and
a processing apparatus, configured to execute the computer program in the storage apparatus to implement a traffic scheduling method for multiple tenants based on elastic block storage, which comprises:
receiving, by a storage node in a storage cluster, a tenant list sent by a control node in the storage cluster, wherein the tenant list is used to maintain tenant names and tenant weights, and the tenant weights represent a proportion of service capabilities for storage enjoyed by respective tenants of the multiple tenants;
determining, by the storage node, a scheduler tree based on the tenant list, wherein the scheduler tree comprises a priority scheduler, a tenant-level scheduler, and a first-in first-out scheduler, the priority scheduler is configured to schedule traffic of the multiple tenants and traffic inside the storage cluster according to business priorities, the tenant-level scheduler is configured to schedule traffic between the multiple tenants, and the first-in first-out scheduler is configured to schedule traffic in and out; and
controlling, based on the scheduler tree, traffic in and out of the storage cluster.

16. The electronic device according to claim 15, wherein the determining, by the storage node, the scheduler tree based on the tenant list comprises:
initially constructing or updating, by the storage node, a scheduler tree with a three-layer tree structure based on the tenant list, wherein a first layer of the scheduler tree with the three-layer tree structure is the priority scheduler, a second layer of the scheduler tree with the three-layer tree structure is the tenant-level scheduler, and a third layer of the scheduler tree with the three-layer tree structure is the first-in first-out scheduler, wherein the priority scheduler is configured to fairly schedule traffic among the business priorities in a manner of round-robin based on service weights of the business priorities, the tenant-level scheduler is configured to fairly schedule traffic among the multiple tenants in a manner of round-robin based on the tenant weights, and the first-in first-out scheduler is configured to schedule traffic based on a first-in first-out principle.

17. The electronic device according to claim 15, wherein the priority scheduler is configured with a plurality of priorities, each of the plurality of priorities is allocated an independent queue, each priority is configured with respective one of the service weights, and isolation and service performance allocation are performed based on the service weights, wherein each priority corresponds to a sub-priority scheduler for serving traffic scheduling of a business corresponding to each priority, wherein a sub-priority scheduler of a first priority of the plurality of priorities is configured to serve the traffic of the multiple tenants on the storage cluster, sub-priority schedulers of other priorities than the first priority are configured to serve the traffic inside the storage cluster, and a service weight corresponding to the first priority is greater than service weights corresponding to the other priorities.

18. The electronic device according to claim 15, wherein the priority scheduler is configured with a plurality of priorities, each of the plurality of priorities corresponds to a sub-priority scheduler for serving traffic scheduling of a business corresponding to each priority, each sub-priority scheduler performs traffic scheduling corresponding to the priority of the each sub-priority scheduler based on a fair round-robin scheduling principle, and in response to a service capability corresponding to any priority being not exhausted, the service capability is supported to be elastically released to other priorities.

19. The electronic device according to claim 15, wherein the tenant-level scheduler, as a sub-layer of the priority scheduler, allocates an independent queue for each tenant of the multiple tenants and configures a sub-tenant-level scheduler for each tenant for performing isolation and service performance allocation according to the tenant weights, and sub-tenant-level schedulers perform traffic scheduling among the multiple tenants based on a fair round-robin scheduling principle.

20. The electronic device according to claim 15, wherein the tenant-level scheduler configures a sub-tenant-level scheduler for each tenant of the multiple tenants for serving traffic scheduling corresponding to each tenant, and in response to a service capability configured for any tenant being not exhausted, the service capability is supported to be elastically released to other tenants.
